(19) United States
(12) Patent Application Publication
(10) Pub. No.: US 2012/0325592 A1
(43) Pub. Date: Dec. 27, 2012

(54) ELEVATOR WITH COMPENSATING DEVICE

(76) Inventors: Hanspeter Bloch, Buchrain (CH); Alessandro D'Apice, Ebikon (CH)

(21) Appl. No.: 13/530,636

(22) Filed: Jun. 22, 2012

(30) Foreign Application Priority Data
Jun. 22, 2011 (EP) 11170896.2

(51) Int. Cl. B66B 7/00

(52) U.S. Cl. 187/414

(57) ABSTRACT

An elevator includes a compensating device having the purpose of providing compensation for changing weight of a support on the cage side or on the counterweight side. Depending on the respective position of an elevator cage and a counterweight in the elevator shaft there are more meters of the support on the cage side or on the counterweight side. In the case of a small support length on the cage side, a large compensating device length on the cage side results and conversely. The compensating device suspended at the elevator cage and at the counterweight forms a loop in a shaft pit and can be set in oscillation. Provided as a remedy are, for example, rods which guide and stabilize the compensating device.

### CROSS-REFERENCE TO RELATED APPLICATION

This application claims the benefit of European Patent Application No. 11170896.2, filed Jun. 22, 2011, which is incorporated herein by reference.

### FIELD

The disclosure relates to an elevator.

### BACKGROUND

An elevator with support means and compensating means has become known from the specification US 2003/0075389. The support means guided over a drive pulley and over a deflecting roller have the purpose of moving an elevator cage and a counterweight up and down in opposite sense in an elevator shaft. The compensating means have the purpose of providing compensation for the changing weight of the support means on the cage side or on the counterweight side. Depending on the respective position of the elevator cage and the counterweight in the elevator shaft more meters of the support means are on the cage side or on the counterweight side. The compensating means arranged at one end below the elevator cage and at the other end below the counterweight act in the case of length or weight on the cage side and on the counterweight side in opposite direction to the length or the weight of the support means on the cage side and on the counterweight side. In the case of a small support means length on the cage side a large compensating means length arises on the cage side and vice versa. The compensating means suspended at the elevator cage and at the counterweight form a loop in the shaft pit and can be set into oscillation particularly in the case of a large conveying height. A guide device which embraces, guides and stabilizes the compensating means is provided as a remedy.

In at least some cases, in case of abrupt movements of the compensating means the guide device can be damaged.

### SUMMARY

At least some of the disclosed embodiments allow for shaft pits of smaller depth than in the case of conventional guide devices. A shaft pit depth of somewhat more than the radius of the compensating means loop can be sufficient. The device can be simple in construction, economic and can be retrofitted independently of the shaft pit depth. Moreover, the device can be adapted to differently constructed compensating means.

### BRIEF DESCRIPTION OF THE DRAWINGS

The disclosed technologies are explained in more detail on the basis of the accompanying figures, in which:

FIG. 1 shows a schematic illustration of an elevator with compensating means,

FIG. 2 shows a plan view of the elevator with a guide device,

FIG. 3 shows the functioning of the guide device and

FIG. 4 shows details of the guide device.

### DETAILED DESCRIPTION

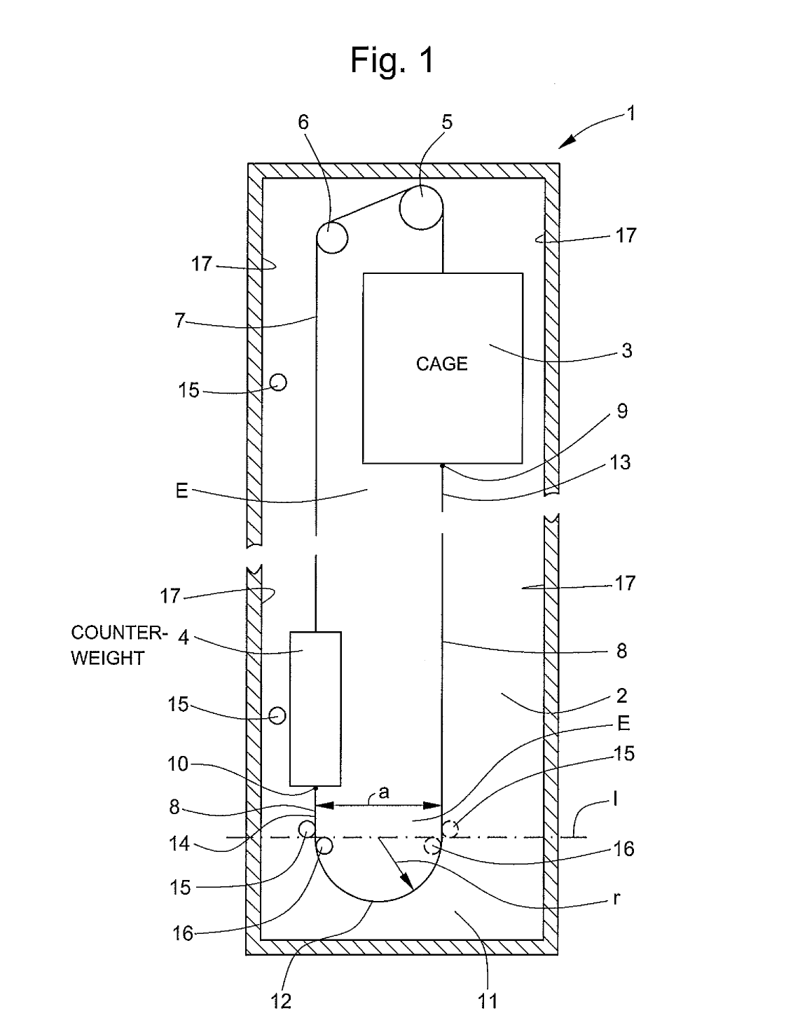

FIG. 1 shows a schematic illustration of an elevator 1 consisting of an elevator shaft 2 in which an elevator cage 3 and a counterweight 4 are movable up and down in opposite directions. A support means 7, for example at least one belt or at least one cable, guided over a drive pulley 5 and a deflecting roller 6 connects the elevator cage 3 with the counterweight 4. An elevator drive (not illustrated) drives the drive pulley 5 and moves the elevator cage 3 or the counterweight 4 in the elevator shaft 2. In FIG. 1 the elevator cage 3 is located at the uppermost story and the counterweight 4 is correspondingly located entirely at the bottom.

The elevator 1 also comprises compensating means 8 which have the purpose of providing compensation for changing weight of the support means 7 on the cage side and on the counterweight side. Support means 7 and compensating means 8 span a vertical plane E. At least one cable, chain or encased chain is, by way of example, provided as compensating means 8.

Depending on the respective position of the elevator cage 3 and the counterweight 4 in the elevator shaft 2, more meters of the support means 7 are on the cage side or on the counterweight side. The compensating means arranged at one end below the elevator cage 3 at a first point 9 and at the other end below the counterweight 4 at a second point 10 act in the case of length or weight on the cage side and on the counterweight side in opposite sense to the length or the weight of the support means on the cage side and on the counterweight side. In the case of a small support means length on the cage side a large compensating means length arises on the cage side and conversely. The compensating means 8 suspended at the elevator cage 3 and at the counterweight 4 form a loop 12 in a shaft pit 11 and can be set into oscillation particularly in the case of a large conveying height. A guide device which guides and stabilizes the compensating means 8 in the plane E can be provided as a remedy.

The compensating means 8 consists of a vertical first run 13 on the cage side, a vertical second run 14 on the counterweight side and the loop 12 in the shaft pit 11. The loop 12, which forms under the line 1, has a radius r which is half the size of the spacing a between the two vertical runs 13, 14.

The above-mentioned guide device consists of at least one first guide element 15 and at least one second guide element 16, wherein the guide elements 15, 16 are arranged along the compensating means 8 and perpendicularly to the plane E and protrude from the plane of the drawing. The first guide means 15 is arranged between the compensating means 8 and a shaft wall 17 and the second guide means 16 is arranged between the two vertical runs 13, 14 or within the loop 12. The first guide element 15 is usually arranged along the path of the compensating means 8 on the counterweight side so that the counterweight 4 can move past. At least one first guide element 15 can also be provided on the cage side particularly in the case of large conveying heights. In this case the guide element is pivotable away so that the elevator cage 3 can move past. In FIG. 1 a first guide element 15 and second element 16 forming a pair is provided on the counterweight side, wherein the first guide element 15 is arranged above the line 1 and between the compensating means 8 and the shaft wall 17 and the second guide element 16 is arranged below the line 1 and within the loop 12. Optionally, as illustrated by a dashed line, such a pair can also be provided on the cage side. Three first guide elements 15 are shown in FIG. 1 on the counterweight side. There can also be a greater or lesser number than three first guide elements 15.

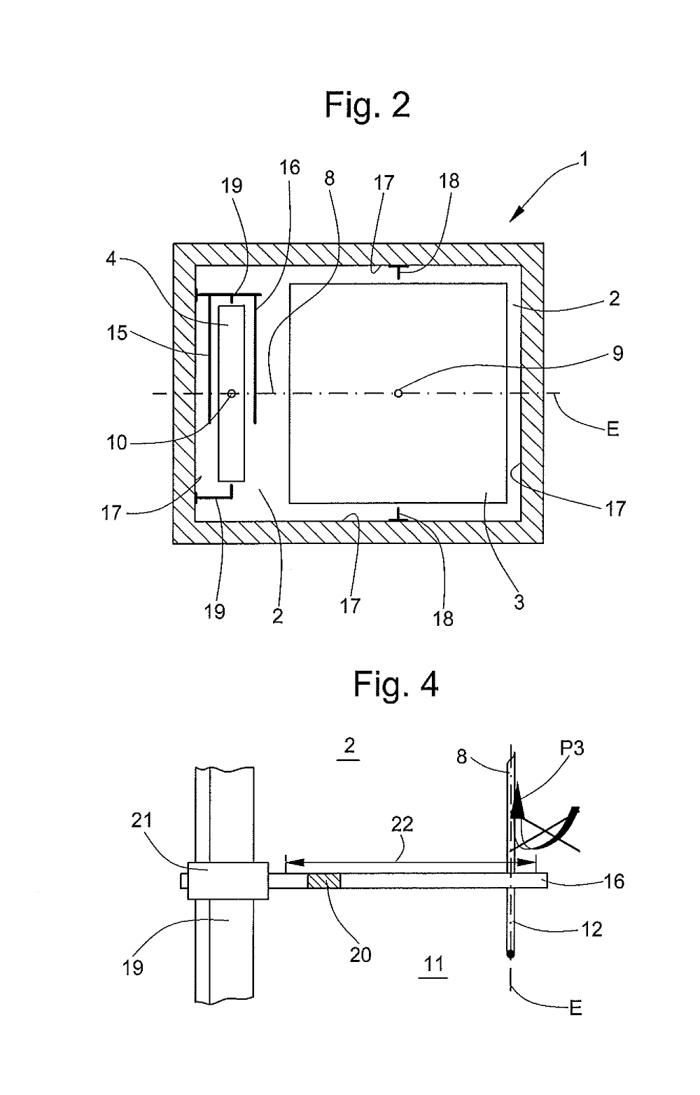

FIG. 2 shows a plan view of the elevator 1 with the guide device consisting of the guide elements 15, 16. The guide elements 15, 16, which are, for example rod-shaped, stand perpendicularly to the plane E, protrude from the plane of the drawing and have a linear section 22. In cross-section the guide elements 15, 16 can be, for example, circularly round, semicircular, oval, etc. A first guide element 15 is arranged between the compensating means 8 and the shaft wall 17 and a second guide element 16 is arranged between the two vertical runs 13, 14 or within the loop 12. The elevator cage 3 is guided at first guide rails 18 arranged in the elevator shaft 2 and the counterweight 4 is guided at second guide rails 19 arranged in the elevator shaft 2. The guide elements 15, 16 are, for example, arranged at the shaft wall 17 or at the guide rails 18, 19. The first guide element 15 can, for example, also be connected at both ends with the shaft wall.

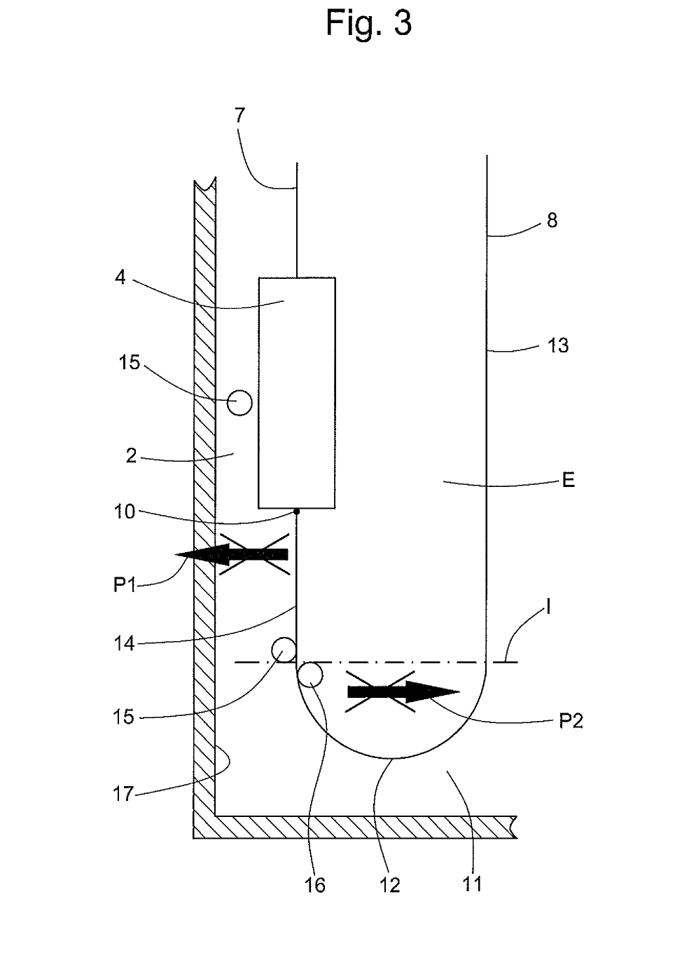

FIG. 3 shows the functioning of the guide device when the compensating means 8 is set in motion. A first arrow denoted by P1 symbolizes the movement of the compensating means 8 in the direction of the shaft wall 17. The compensating means 8 can, particularly in the case of a large number of meters of compensating means 8 on the counterweight side, hit against the shaft wall 17 and in that case amplify the intrinsic sideways movement. The first arrow P1 crossed out in FIG. 3 signifies that the movement of the compensating means 8 predominantly in the plane E or towards the shaft wall 17 is reduced or limited by means of the first guide elements 15. A second arrow denoted by P2 symbolizes the movement of the loop 12. The second arrow P2 crossed out in FIG. 3 signifies that the movement of the loop 12 predominantly in the plane E is reduced or limited by means of the second guide element 16. In the longitudinal direction of the guide elements 15, 16 or perpendicularly the plane E the movements of the compensating means are not reduced or limited by the guide elements 15, 16.

FIG. 4 shows details of the guide device, particularly of the second guide element 16. A third arrow denoted by P3 symbolizes an abrupt movement of the loop 12. Such movements arise, for example, in the case of travel of the elevator cage 3 or the counterweight 4 onto a buffer. The loop 12 jumps upwardly and deflects the second guide element 16. The second guide element 16 has a defined bending point 20 and as a consequence of the bending point is deflectable without accepting damage. As soon as the loop 12 again adopts its original position the second guide element 16 moves back into its original horizontal position at right angles to the plane E. The third arrow crossed out in FIG. 4 signifies that the abrupt movement of the loop 12 is prevented or limited by means of the second guide element 16. The defined bending point 20 can comprise, for example, a spring element or a hydraulic element. As indicated in FIG. 2 the second spring element 16 can be arranged by means of a fastening device 21 at the second guide rail 19.

The surfaces of the rod-shaped guide elements 15, 16 can have good slide properties for the compensating means 8. As an alternative, it is also possible to provide, instead of the rod-shaped guide elements 15, 16, rod-shaped rollers which are drivable by the compensating means 8.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. We therefore claim as our invention all that comes within the scope and spirit of these claims.

We claim:

1. An elevator comprising:
an elevator cage disposed in a shaft;
a counterweight disposed in the shaft;
a support coupled to the elevator cage and the counterweight;
a compensating device coupled to the elevator cage and the counterweight; and
a guide device coupled to the compensating device, the guide device comprising first and second guide elements, each of the first and second guide elements comprising respective linear sections, the linear sections limiting movements in a plane spanned by the support and the compensating device, the linear section of the second guide element comprising a defined bending point.

2. The elevator of claim 1, the first and second guide elements being arranged perpendicular to the plane spanned by the support and the compensating device.

3. The elevator of claim 1, the first and second guide elements being positioned at an end of a loop formed by the compensating device.

4. The elevator of claim 3, the first guide element being positioned outside of the loop and the second guide element being positioned inside of the loop.

5. The elevator of claim 1, the first guide element being arranged at the compensating device and between the compensating device and a wall of the shaft.

6. The elevator of claim 1, the first guide element further comprising a rod-shaped portion, the rod-shaped portion having low friction relative to the compensating device.

7. The elevator of claim 1, the first guide element further comprising a rod-shaped roller.

8. The elevator of claim 1, the second guide element further comprising a rod-shaped portion, the rod-shaped portion having low friction relative to the compensating device.

9. The elevator of claim 1, the second guide element further comprising a rod-shaped roller.

10. The elevator of claim 1, the bending point comprising a spring.

11. The elevator of claim 1, the bending point comprising a hydraulic element.

12. The elevator of claim 1, the support comprising a belt.

13. The elevator of claim 1, the support comprising a cable.

14. The elevator of claim 1, the compensating device comprising a cable.

15. The elevator of claim 1, the compensating device comprising a chain.
